(19) United States
(12) Patent Application Publication
(10) Pub. No.: US 2024/0249205 A1
(43) Pub. Date: Jul. 25, 2024

(54) INFORMATION PROCESSING APPARATUS, INFORMATION PROCESSING METHOD, AND STORAGE MEDIUM

(71) Applicant: NEC Corporation, Minato-ku, Tokyo (JP)

(72) Inventors: Yuta HATAKEYAMA, Tokyo (JP); Yuzuru OKAJIMA, Tokyo (JP)

(73) Assignee: NEC Corporation, Minato-ku ,Tokyo (JP)

(21) Appl. No.: 18/561,357

(22) PCT Filed: May 27, 2021
(86) PCT No.: PCT/JP2021/020115

§ 371 Date: Nov. 16, 2023

(51) Int. Cl. G06N 20/20

(52) U.S. Cl. CPC G06N 20/20

(57) ABSTRACT

In order to make it possible to generate a synthetic instance for more efficiently improve prediction accuracy of a machine learning model, an information processing apparatus (10) includes: an acquisition section (11) for acquiring a plurality of training instances; a selection section (12) for selecting, from the plurality of training instances, two or more training instances each of which derives one or more uncertain prediction results obtained using one or more machine learning models that output prediction results while using instances as input; and a generation section (13) for generating a synthetic instance by combining the two or more training instances which have been selected by the selection section (12).

### TECHNICAL FIELD

The present invention relates to a technique for generating an instance to be used in machine learning.

### BACKGROUND ART

It is known that accuracy of inference by a machine learning model depends on the number and content of training instances used in constructing the machine learning model. A technique is known in which, in order to improve inference accuracy of a machine learning model, a training instance is reinforced by generating a synthetic instance from training instances which have been prepared in advance. For example, Non-patent Literature 1 indicates that an instance (training instance) of a minority class that is nearest to a decision boundary of a support vector machine and an instance of a minority class near that instance are combined to generate a virtual instance of a minority class.

### CITATION LIST

### Non-Patent Literature

### Non-Patent Literature 1

Seyda Ertekin, “Adaptive Oversampling for Imbalanced Data Classification”, Information Sciences and Systems 2013, proceedings of the 28th International Symposium on Computer and Information Sciences (ISCIS), pp. 261-269, 2013

### SUMMARY OF INVENTION

### Technical Problem

However, there is a possibility that a virtual instance generated by the technique disclosed in Non-patent Literature 1 is generated at a location farther from the decision boundary than an instance of a minority class that is nearest to the decision boundary. A synthetic instance generated at such a location does not necessarily efficiently improve estimation accuracy of the support vector machine. As such, the synthetic instance generated by the technique disclosed in Non-patent Literature 1 has room for improvement in efficiency of enhancing estimation accuracy of a machine learning model.

An example aspect of the present invention is accomplished in view of the above problem, and an example object thereof is to provide a technique for generating a synthetic instance that more efficiently improves prediction accuracy of a machine learning model.

### Solution to Problem

An information processing apparatus in accordance with an example aspect of the present invention includes: an acquisition means for acquiring a plurality of training instances; a selection means for selecting, from the plurality of training instances, two or more training instances each of which derives one or more uncertain prediction results obtained using one or more machine learning models that output prediction results while using instances as input; and a generation means for generating a synthetic instance by combining the two or more training instances which have been selected by the selection means.

An information processing method in accordance with an example aspect of the present invention includes: acquiring, by an information processing apparatus, a plurality of training instances; selecting, from the plurality of training instances by the information processing apparatus, two or more training instances each of which derives one or more uncertain prediction results obtained using one or more machine learning models that output prediction results while using instances as input; and generating, by the information processing apparatus, a synthetic instance by combining the two or more training instances which have been selected.

A program in accordance with an example aspect of the present invention is a program for causing a computer to function as an information processing apparatus, the program causing the computer to function as: an acquisition means for acquiring a plurality of training instances; a selection means for selecting, from the plurality of training instances, two or more training instances each of which derives one or more uncertain prediction results obtained using one or more machine learning models that output prediction results while using instances as input; and a generation means for generating a synthetic instance by combining the two or more training instances which have been selected by the selection means.

### Advantageous Effects of Invention

According to an example aspect of the present invention, it is possible to generate a synthetic instance that more efficiently improves prediction accuracy of a machine learning model.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a flow of an information processing method in accordance with the first example embodiment of the present invention.

FIG. 3 is a diagram schematically illustrating a specific example of the information processing method in accordance with the first example embodiment of the present invention.

FIG. 4 is a block diagram illustrating a configuration of an information processing apparatus in accordance with a second example embodiment of the present invention.

FIG. 5 is a flowchart illustrating a flow of an information processing method in accordance with the second example embodiment of the present invention.

FIG. 6 is a diagram schematically illustrating a specific example of a first selection process in accordance with the second example embodiment of the present invention.

FIG. 7 is a diagram schematically illustrating a specific example of a second selection process in accordance with the second example embodiment of the present invention.

FIG. 8 is a flowchart illustrating a flow of a generation process in accordance with a third example embodiment of the present invention.

FIG. 9 is a flowchart illustrating a flow of a first generation process in accordance with the third example embodiment of the present invention.

FIG. 10 is a flowchart illustrating a flow of a second generation process in accordance with the third example embodiment of the present invention.

FIG. 11 is a diagram schematically illustrating a specific example of the information processing method in accordance with a fourth example embodiment of the present invention.

FIG. 12 is a flowchart illustrating a flow of an information processing method in accordance with a fifth example embodiment of the present invention.

FIG. 13 is a flowchart illustrating a flow of an information processing method in accordance with a sixth example embodiment of the present invention.

FIG. 14 is a block diagram illustrating a configuration of a computer that functions as the information processing apparatuses in accordance with the first through sixth example embodiments of the present invention.

### EXAMPLE EMBODIMENTS

### First Example Embodiment

The following description will discuss a first example embodiment of the present invention in detail, with reference to the drawings. The present example embodiment is a basic form of example embodiments described later.

### <Configuration of Information Processing Apparatus>

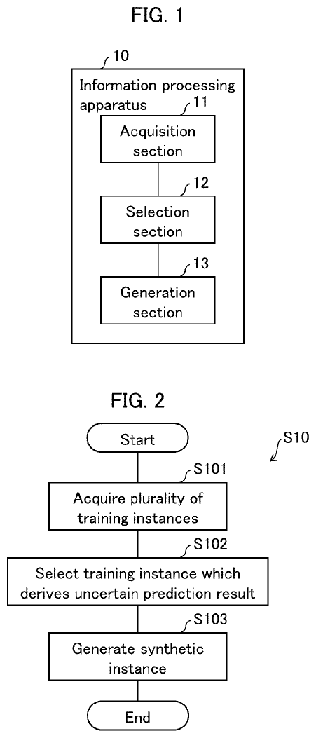

The following description will discuss a configuration of an information processing apparatus 10 in accordance with the present example embodiment, with reference to FIG. 1. FIG. 1 is a block diagram illustrating the configuration of the information processing apparatus 10. The information processing apparatus 10 is an apparatus which generates, from a plurality of instances, a synthetic instance for use in training of a machine learning model.

As illustrated in FIG. 1, the information processing apparatus 10 includes an acquisition section 11, a selection section 12, and a generation section 13. The acquisition section 11 is an example configuration for realizing the acquisition means recited in claims. The selection section 12 is an example configuration for realizing the selection means recited in claims. The generation section 13 is an example configuration for realizing the generation means recited in claims.

The acquisition section 11 acquires a plurality of training instances. The selection section 12 selects, from the plurality of training instances acquired by the acquisition section 11, two or more training instances each of which derives one or more uncertain prediction results obtained using one or more machine learning models that output prediction results while using instances as input. The generation section 13 generates a synthetic instance by combining two or more training instances which have been selected by the selection section 12.

### (Instance, Training Instance, Synthetic Instance)

An instance is information input into a machine learning model, and includes a feature quantity. In other words, the instance is present in a feature quantity space. A training instance is an instance usable in training of each of one or more machine learning models. The training instance may be an instance obtained by observation or may be a synthetic instance that has been synthetically generated.

### (Machine Learning Model)

Each of one or more machine learning models outputs a prediction result while using an instance as input. The prediction result may include, for example, a prediction probability that each of a plurality of labels would be predicted. In this case, a label with the highest prediction probability may be referred to as the prediction result. Each of the one or more machine learning models is, for example, a model generated using a machine learning algorithm such as a decision tree, a neural network, a random forest, or a support vector machine. Note, however, that the machine learning algorithm used in generating each machine learning model is not limited to these examples. The one or more machine learning models may be, for example, stored in a memory of the information processing apparatus 10 or stored in another apparatus which is communicably connected to the information processing apparatus 10.

At least one of or all of one or more machine learning models may each be a model which has been trained using at least one of or all of a plurality of training instances which are acquired by the acquisition section 11. Alternatively, at least one of or all of the one or more machine learning models may each be a model which has been trained using a training instance other than the training instances which are acquired by the acquisition section 11.

The one or more machine learning models do not all necessarily need to be “a machine learning model to be trained using a generated synthetic instance”. In other words, the one or more machine learning models may include at least one of or all of machine learning models to be trained. The one or more machine learning models do not need to include a machine learning model to be trained. The number of machine learning models to be trained may be two or more or may be one.

(Training Instance which Derives Uncertain Prediction Result)

A training instance which derives an uncertain prediction result is a training instance for which reliability of a prediction result(s) obtained by one or more machine learning models is low. In other words, the training instance which derives an uncertain prediction result is, for example, a training instance for which a result of evaluating uncertainty satisfies a predetermined condition. More specifically, the training instance which derives an uncertain prediction result is, for example, a training instance which derives variation in a plurality of prediction results obtained using a plurality of machine learning models. In this case, evaluation of uncertainty means to evaluate variation in a plurality of prediction results, for example, to evaluate whether or not variation is large.

Here, a training instance which derives variation in a plurality of prediction results is a training instance for which a result of variation evaluation indicates that “variation is large”. For example, evaluation of variation is to evaluate whether or not variation in a plurality of prediction results is large. As a specific example, the evaluation of variation may be evaluation based on vote entropy. The vote entropy will be described later in detail in the second example embodiment. The evaluation of variation may be evaluation based on a proportion of prediction results that indicate the same label among a plurality of prediction results. Note, however, that the evaluation of variation is not limited to those described above. Hereinafter, a “training instance that has been evaluated to derive large variation in a plurality of prediction results” is also referred to as a “training instance which derives variation in prediction results”. Moreover, a “training instance that has been evaluated not to derive large variation in a plurality of prediction results” is also referred to as a “training instance which derives small variation in prediction results”.

The training instance which derives an uncertain prediction result is, for example, a training instance which is present near a decision boundary of a feature quantity space of at least one machine learning model. In this case, evaluation of uncertainty means to evaluate whether or not the training instance is present near the decision boundary, and the predetermined condition means a condition of being present near the decision boundary.

### <Flow of Information Processing Method>

The following description will discuss a flow of an information processing method S10 in accordance with the present example embodiment, with reference to FIG. 2. FIG. 2 is a flowchart illustrating the flow of the information processing method S10.

### (Step S101)

In step S101 (acquisition process), the acquisition section 11 acquires a plurality of training instances. For example, the acquisition section 11 may acquire a plurality of training instances by reading those from a memory. Alternatively, for example, the acquisition section 11 may acquire a plurality of training instances from an input apparatus or may acquire a plurality of training instances from an apparatus which is connected via a network. The plurality of training instances acquired in this step include one or both of an observation instance and a synthetic instance.

### (Step S102)

In step S102 (selection process), the selection section 12 selects, from the plurality of training instances, two or more training instances each of which derives one or more uncertain prediction results obtained using one or more machine learning models that output prediction results while using instances as input.

### (Step S103)

In step S103 (generation process), the generation section 13 generates a synthetic instance by combining two or more training instances which have been selected in step S102. The generation section 13 may generate a single synthetic instance by combining two training instances or may generate a single synthetic instance by combining three or more training instances. The generation section 13 may generate a single synthetic instance or may generate a plurality of synthetic instances. For example, the generation section 13 generates a synthetic instance according to formula (1) below.

$${\hat{x}}_{v} = λ {x}_{i} + ( 1 - λ ) {x}_{j} \qquad ( 1 )$$

In formula (1), \hat{ }xᵥ represents a synthetic instance, and xᵢ and xⱼ each represent a training instance which has been selected by the selection section 12. λ is a weight coefficient that satisfies 0≤λ≤1. The generation section 13 decides, for example, a value of the coefficient λ using a random number which has been generated by a random function. Note that the generation process carried out by the generation section 13 is not limited to the above-described technique, and the generation section 13 may combine a plurality of training instances by another technique.

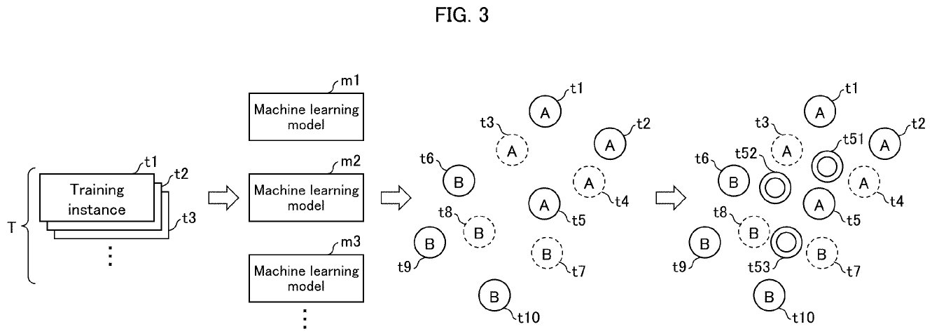

FIG. 3 is a diagram schematically illustrating a specific example of the information processing method S10. FIG. 3 illustrates an example case in which a plurality of machine learning models mj (j=1, 2, 3, and so forth) are used by the selection section 12. In the present specific example, a training instance group T which is acquired by the acquisition section 11 in step S101 includes training instances t1, t2, t3, and so forth. Each of the plurality of machine learning models mj is a model which has been trained to output a label indicating “A” or “B” as a prediction result, upon input of an instance.

In FIG. 3, the selection section 12 inputs, into each of the plurality of machine learning models mj, a plurality of training instances t1 through t10 to be evaluated. Thus, the selection section 12 obtains a plurality of prediction results including prediction results output from the machine learning model m1, prediction results output from the machine learning model m2, prediction results output from the machine learning model m3, and so forth. Moreover, the selection section 12 selects, based on the plurality of prediction results, training instances t3, t4, t7, and t8 each of which derives an uncertain prediction result, from among the plurality of training instances t1 through t10.

Moreover, in FIG. 3, the generation section 13 generates a training instance t51 by combining the training instance t3 and the training instance t4 which have been selected by the selection section 12. Moreover, the generation section 13 generates a training instance t52 by combining the training instance t3 and the training instance t8 which have been selected by the selection section 12. Moreover, the generation section 13 generates a training instance t53 by combining the training instance t7 and the training instance t8 which have been selected by the selection section 12.

### Example Advantage of Present Example Embodiment

As described above, the information processing apparatus 10 in accordance with the present example embodiment employs the configuration of: selecting, from a plurality of training instances, two or more training instances each of which derives one or more uncertain prediction results obtained using one or more machine learning models that output prediction results while using instances as input; and generating a synthetic instance by combining the two or more selected training instances each of which derives one or more uncertain prediction results. It is highly likely that a synthetic instance obtained by combining two or more training instances each of which derives an uncertain prediction result is generated at a location which is short of a prediction result. Therefore, by training a machine learning model using the generated synthetic instance, it is possible to more efficiently improve prediction accuracy of the machine learning model to be trained.

### Second Example Embodiment

The following description will discuss a second example embodiment of the present invention in detail, with reference to the drawings. The same reference numerals are given to constituent elements which have functions identical with those described in the first example embodiment, and descriptions as to such constituent elements are not repeated.

### <Configuration of Information Processing Apparatus>

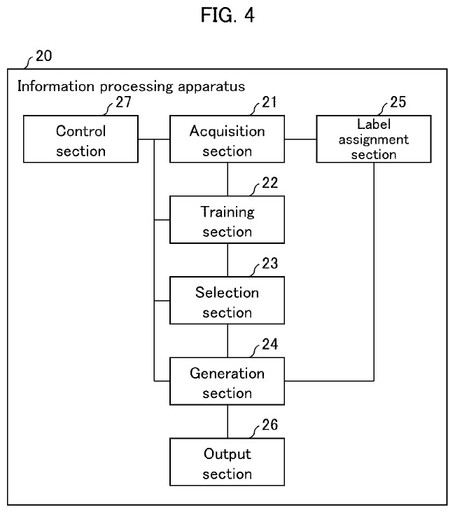

The following description will discuss a configuration of an information processing apparatus 20 in accordance with the present example embodiment, with reference to FIG. 4. FIG. 4 is a block diagram illustrating the configuration of the information processing apparatus 20. The information processing apparatus 20 is an apparatus which generates a synthetic instance for use in training of a machine learning model. The information processing apparatus 20 includes an acquisition section 21, a training section 22, a selection section 23, a generation section 24, a label assignment section 25, an output section 26, and a control section 27. The training section 22 is an example configuration for realizing the training means recited in claims. The label assignment section 25 is an example configuration for realizing the label assignment means recited in claims. The output section 26 is an example configuration for realizing the output means recited in claims.

The acquisition section 21 is configured in a manner similar to the acquisition section 11 in the first example embodiment. The training section 22 trains at least one of or all of one or more machine learning models using at least one of or all of a plurality of training instances which have been acquired by the acquisition section 21. Hereinafter, in a case where a plurality of machine learning models are used, the “plurality of machine learning models” are also referred to as a “machine learning model group”.

The one or more machine learning models include, for example, a machine learning model to be trained using a synthetic instance generated by the information processing apparatus 20. At least one of the one or more machine learning models may be, for example, a decision tree.

The selection section 23 selects, from the plurality of training instances acquired by the acquisition section 21, two or more training instances each of which derives one or more uncertain prediction results obtained using one or more machine learning models that output prediction results while using instances as input. The selection process carried out by the selection section will be described later.

The generation section 24 generates a synthetic instance by combining two or more training instances which have been selected by the selection section 23. For example, the generation section 24 generates a synthetic instance by carrying out a combining process according to formula (1) described above.

The label assignment section 25 assigns a label(s) to at least one of or all of the plurality of training instances and the synthetic instance. The label assignment section 25 may assign a label based on, for example, information output from an input apparatus which receives a user operation. Alternatively, for example, the label assignment section 25 may assign a label obtained by inputting a training instance and a synthetic instance into a machine learning model which has been trained to output a label while using instances as input. In this case, the machine learning model that outputs a label is, for example, a model having higher prediction accuracy than at least one machine learning model or a machine learning model to be trained. In a case where the machine learning model to be trained is a decision tree, the machine learning model that outputs a label is, for example, a random forest.

The output section 26 outputs a synthetic instance generated by the generation section 24. The output section 26 may, for example, cause a storage medium such as an external storage apparatus to store the synthetic instance generated by the generation section 24. The output section 26 may output the synthetic instance to an output apparatus such as a display apparatus, for example.

The control section 27 controls each section of the information processing apparatus 20. In the present example embodiment, in particular, the control section 27 adds the synthetic instance generated by the generation section 24 to the plurality of training instances, and causes the acquisition section 21, the training section 22, the selection section 23, and the generation section 24 to function again.

### <Flow of Information Processing Method>

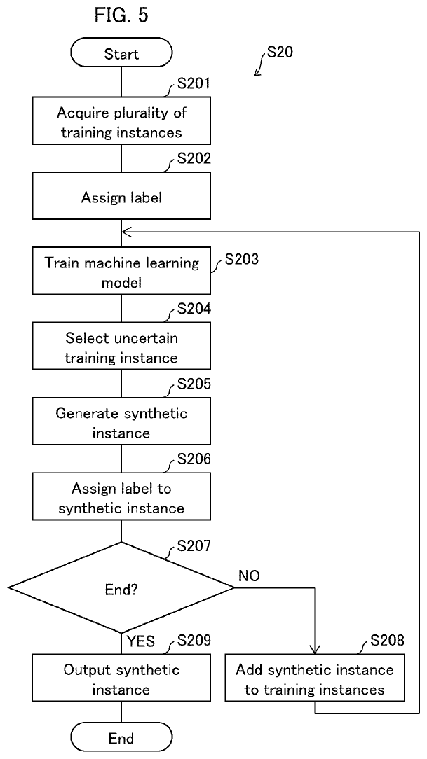

The following description will discuss a flow of an information processing method S20 which is carried out by the information processing apparatus 20 configured as described above, with reference to FIG. 5. FIG. 5 is a flowchart illustrating the flow of the information processing method S20.

### (Step S201)

In step S201, the acquisition section 21 acquires a plurality of training instances. The plurality of training instances to be acquired may include an instance obtained by observation or may include a synthetic instance.

### (Step S202)

In step S202, the label assignment section 25 assigns a label to each of the plurality of training instances which have been acquired by the acquisition section 21.

### (Step S203)

In step S203, the training section 22 trains one or more machine learning models using at least one of or all of the plurality of training instances which have been acquired by the acquisition section 21. For example, the training section 22 trains each of the one or more machine learning models using a training instance group Dj. The training instance group Dj is a training instance group used in training of a machine learning model. The training instance group is a set of training instances which have been randomly extracted by the training section 22 from a plurality of training instances acquired by the acquisition section 21. A training instance group used in training of a certain machine learning model may partially or entirely overlap with a training instance group used in training of another machine learning model.

In a case of using a plurality of machine learning models, for example, it is possible that at least two machine learning models included in the plurality of machine learning models use machine learning algorithms which are different from each other. Alternatively, in a case where a plurality of machine learning models are used, for example, the plurality of machine learning models may use a single machine learning algorithm.

### (Step S204)

In step S204, the selection section 23 selects, from the plurality of training instances acquired by the acquisition section 21, two or more training instances each of which derives one or more uncertain prediction results that are obtained using one or more machine learning models. The selection process carried out by the selection section 23 will be described later. In the following description, a training instance which is selected by the selection section 23 is also referred to as an “uncertain training instance”.

### (Step S205)

In step S205, the generation section 24 generates a synthetic instance by combining two or more training instances which have been selected by the selection section 23. For example, the generation section 24 generates a synthetic instance by carrying out a combining process according to formula (1) described above. Alternatively, as a technique for combining a plurality of training instances, the generation section 24 may use a known technique such as, for example, MUNGE (see Reference Literature 1) or SMOTE (see Reference Literature 2).
[Reference Literature 1] Bucilua, C., Caruana, R. and Niculescu-Mizil, A., “Model Compression”, Proc. ACM SIGKDD, pp. 535-541 (2006)
[Reference Literature 2] Chawla, N. V., Bowyer, K. W., Hall, L. O., and Kegelmeyer, W. P., “SMOTE: Synthetic minority over-sampling technique”, Journal of Artificial Intelligent Research, 16, 321-357 (2002).

In a case where the number of training instances selected by the selection section 23 is three or more, the generation section 24 generates a synthetic instance by combining some of or all of the training instances selected by the selection section 23. In a case of combining some of the training instances selected by the selection section 23, the generation section 24 identifies, as subjects to be combined, some of the training instances selected by the selection section 23, and generates a synthetic instance by combining the identified training instances. The number of training instances which are identified by the generation section 24 as subjects to be combined may be two or may be three or more.

For example, the generation section 24 may randomly identify a plurality of training instances or may identify a plurality of training instances each of which has a distance that is equal to or less than a threshold in a feature quantity space, as subjects to be combined among a plurality of training instances which have been selected by the selection section 23. Note that a technique for identifying, by the generation section 24, a training instance to be combined is not limited to these examples.

### (Step S206)

In step S206, the label assignment section 25 assigns a label to each of one or more synthetic instances generated by the generation section 24.

### (Step S207)

In step S207, the control section 27 determines whether or not to end the training process. For example, in a case where the number of times of carrying out the processes of steps S203 through S206 is equal to or more than a predetermined threshold, the control section 27 determines to end the training process. Meanwhile, in a case where the number of times of carrying out the processes of steps S203 through S206 is less than the predetermined threshold, the control section 27 determines not to end the training process. In a case where the training process does not end (NO in step S207), the control section 27 proceeds to a process of step S208. Meanwhile, in a case where the training process ends (YES in step S207), the control section 27 proceeds to a process of step S209.

### (Step S208)

In step S208, the control section 27 adds, to the plurality of training instances, one or more synthetic instances to each of which a label has been assigned. After completion of the process of step S208, the control section 27 returns to the process of step S203. In other words, the control section 27 adds the synthetic instance to the plurality of training instances, and causes the acquisition section 21, the training section 22, the selection section 23, and the generation section to function again.

### (Step S209)

In step S209, the output section 26 outputs a synthetic instance generated by the generation section 24. For example, the output section 26 outputs, among synthetic instances generated by the generation section 24, one or more synthetic instances each of which derives one or more uncertain prediction results that are obtained using one or more machine learning models which have been trained by the training section 22.

### <Selection Process of Training Instance to be Combined>

The following description will discuss a first selection process through a third selection process as a specific example of a training instance selection process carried out by the selection section 23. In the first selection process, two or more training instances selected by the selection section 23 include, for example, a training instance which derives variation in a plurality of prediction results obtained using a plurality of machine learning models. In the second selection process, two or more training instances selected by the selection section 23 include, for example, a training instance that is present near a decision boundary of a feature quantity space of at least one machine learning model. In the third selection process, the selection section 23 selects a training instance using a prediction probability of at least one machine learning model.

The selection section 23 selects, by carrying out at least one of the first selection process through the third selection process, a training instance to be combined. Note that the selection process carried out by the selection section 23 is not limited to these, and the selection section 23 may select a training instance which derives an uncertain prediction result by another technique.

### (First Selection Process)

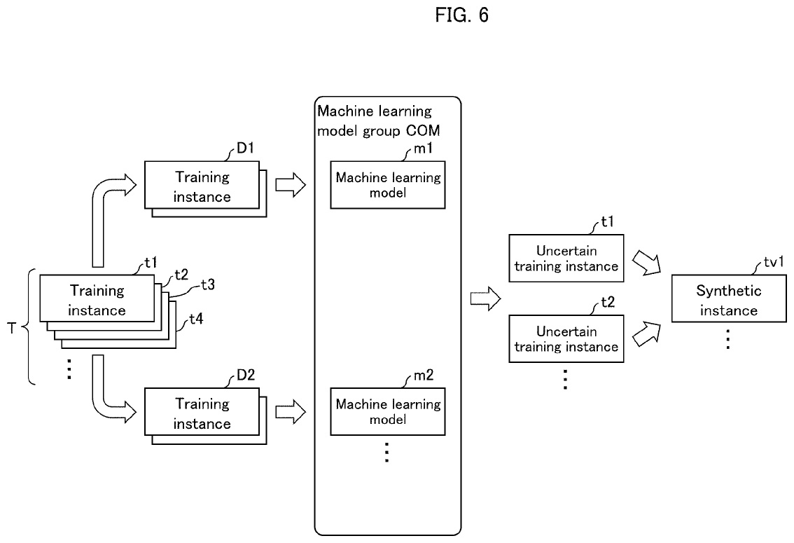

The first selection process is a process that can be carried out using a plurality of machine learning models. In the first selection process, the selection section 23 selects a training instance which derives variation in a plurality of prediction results obtained using a plurality of machine learning models. FIG. 6 is a diagram schematically illustrating a specific example of the first selection process. In FIG. 6, a training instance group T includes a plurality of training instances t1, t2, t3, and so forth. A machine learning model group COM includes a plurality of machine learning models m1, m2, and so forth. The machine learning model m1 is a model which has been trained by the training section 22 using a training instance group D1 included in the training instance group T. The machine learning model m2 is a model which has been trained by the training section 22 using a training instance group D2 included in the training instance group T. As such, the machine learning model mj (i=1, 2, and so forth) is a model which has been trained by the training section 22 using a training instance group Dj included in the training instance group T.

In FIG. 6, the selection section 23 selects, with use of the plurality of machine learning models mj which have been trained by the training section 22, a training instance to be combined. In this example, the selection section 23 inputs, into each of the plurality of machine learning models mj, a plurality of training instances to be evaluated among the training instance group T which has been acquired by the acquisition section 21. Thus, the selection section 23 obtains a plurality of prediction results including prediction results output from the machine learning model m1, prediction results output from the machine learning model m2, and so forth. Moreover, the selection section 23 selects training instances t1, t2, and so forth each of which derives variation in prediction results of the plurality of machine learning models mj. A training instance (i.e., a training instance to be evaluated) which is input by the selection section 23 into the plurality of machine learning models mj is, for example, a training instance which has not been used by the training section 22 in training of any machine learning model mj among the training instance group T.

At this time, the selection section 23 selects, for example, a training instance which derives variation in prediction results, with use of an index of vote entropy in a technique of query by committee (QBC). For example, formula (2) below indicates that a training instance \hat{ }x which provides maximum vote entropy is selected.

$$\hat{x} = {arg max}_{x} ( - {\sum }_{y} \frac{V ( y )}{C} log \frac{V ( y )}{C} ) \qquad ( 2 )$$

In formula (2), C represents a total number of machine learning models. V(y) represents the number of machine learning models each of which has predicted a label y. The selection section 23 may select \hat{ }x, which is indicated by formula (2), as a training instance which derives variation in prediction results. The selection section 23 may select, for example, a predetermined number of training instances t1, t2, and so forth in order of decreasing entropy, or may select training instances t1, t2 and so forth each of which provides entropy equal to or greater than a threshold.

For example, a case will be described in which prediction results obtained by inputting the training instances t1 through t3 to be evaluated into each of the machine learning models m1 and m2 are as follows.
A prediction result in a case where the training instance t1 has been input into the machine learning model m1 is “A”, and a prediction result in a case where the training instance t1 has been input into the machine learning model m2 is “B”.
A prediction result in a case where the training instance t2 has been input into the machine learning model m1 is “A”, and a prediction result in a case where the training instance t2 has been input into the machine learning model m2 is “B”.
A prediction result in a case where the training instance t3 has been input into the machine learning model m1 is “A”, and a prediction result in a case where the training instance t3 has been input into the machine learning model m2 is “A”.

In this case, the selection section 23 selects training instances t1 and t2, each of which provides maximum entropy, as training instances each of which derives an uncertain prediction result. The generation section 24 generates a synthetic instance tv1 by combining the training instance t1 and the training instance t2 which have been selected by the selection section 23.

### (Second Selection Process)

Next, the second selection process carried out by the selection section 23 will be described. The second selection process is a process that can be carried out, in a case where at least one machine learning model is a support vector machine, using that machine learning model. In the second selection process, the selection section 23 selects a training instance which is present near a decision boundary in a feature quantity space of that machine learning model.

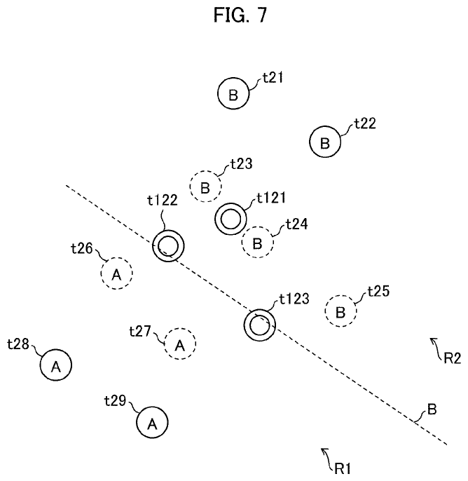

FIG. 7 is a diagram schematically illustrating a specific example of the second selection process. In this example, the selection section 23 selects, as training instances each of which derives an uncertain prediction result, a plurality of training instances that are present near a decision boundary B indicated by that machine learning model. The selection section 23 may select, for example, a training instance which is apart from the decision boundary B by a distance that is equal to or less than a predetermined threshold. Alternatively, for example, the selection section 23 may select a predetermined number of training instances in order of increasing distance from the decision boundary B. In the example illustrated in FIG. 7, the selection section 23 selects, from a plurality of training instances t21 through t29, five training instances t23 through t27 in order of increasing distance from the decision boundary B.

The selection section 23 may select, from the plurality of training instances, a plurality of training instances which are included in one of a plurality of spaces partitioned by the decision boundary B in the feature quantity space. Alternatively, the selection section 23 may select, from the plurality of training instances, a training instance which is included in each of a plurality of spaces partitioned by the decision boundary B in the feature quantity space. In other words, the selection section 23 may select a plurality of training instances for each of which the same label has been predicted, or may select training instances for which different labels have been predicted.

In the example illustrated in FIG. 7, the generation section 24 generates a synthetic instance t121 by combining training instances t23 and t24 included in a space R2 among spaces R1 and R2 partitioned by the decision boundary B. Moreover, the generation section 24 generates a synthetic instance t122 by combining the training instance t24 included in the space R2 and the training instance t26 included in the space R1. Moreover, the generation section 24 generates a synthetic instance t123 by combining the training instance t25 included in the space R2 and the training instance t27 included in the space R1. Here, the synthetic instance t122 obtained by combining training instances included in the respective spaces R1 and R2 is generated nearer the decision boundary B, as compared with the training instances t23 and t24 used in combining. Moreover, the synthetic instance t123 obtained by combining training instances included in the respective spaces R1 and R2 is generated nearer the decision boundary B, as compared with the training instances t25 and t27 used in combining.

### (Third Selection Process)

Next, the third selection process carried out by the selection section 23 will be described. The third selection process is a process that can be carried out using at least one machine learning model. In the third selection process, the selection section 23 selects a training instance using a prediction probability of each label output from the machine learning model. For example, the selection section 23 selects an uncertain training instance \hat{ }x according to formula (3) or formula (4) below.

$$\hat{x} = {arg min}_{x} ( {max}_{y} P ( y \vert x ) ) \qquad ( 3 )$$

$$\hat{x} = {arg min}_{x} ( P ( {y}_{1} \vert x ) - ( P ( {y}_{2} \vert x ) ) \qquad ( 4 )$$

Formula (3) is a formula expressing a technique of so-called least confident in which a training instance \hat{ }x is selected which derives a minimum prediction probability maxP(y|x) of a “label y having a maximum prediction probability”.

Formula (4) is a formula expressing a technique of so-called margin sampling in which a training instance \hat{ }x is selected which derives a minimum difference between a prediction probability P(y1|x) of a “label y1 having a highest prediction probability” and a prediction probability P(y1|x) of a “label y2 having a second highest prediction probability”.

### Example Advantage of Present Example Embodiment

In the information processing apparatus 20 in accordance with the present example embodiment, one or more machine learning models are trained using at least one of or all of the plurality of training instances which have been acquired by the acquisition section 21, and then a training instance to be combined is selected with use of the one or more machine learning models which have been trained. A machine learning model to be trained is trained using a synthetic instance generated by the information processing apparatus 20, and it is therefore possible to more effectively improve prediction accuracy of the machine learning model to be trained.

In particular, in a case where the machine learning model to be trained is a decision tree, the decision tree may vary greatly in structure of the tree merely by slightly altering a training instance. Therefore, prediction accuracy of the decision tree is lower than prediction accuracy of other complex machine learning models. According to the present example embodiment, a machine learning model to be trained is trained using a synthetic instance generated by the information processing apparatus 20. Therefore, it is possible to more effectively improve prediction accuracy of the machine learning model to be trained, such as a decision tree.

Moreover, according to the present example embodiment, in the first selection process, the information processing apparatus 20 selects a training instance which derives variation in a plurality of prediction results obtained by using a plurality of machine learning models. By training a machine learning model using a synthetic instance obtained by combining training instances which have been selected, it is possible to more effectively improve prediction accuracy of the machine learning model to be trained.

In the example illustrated in FIG. 7 in accordance with the present example embodiment, the synthetic instance t122 is generated at a position closer to the decision boundary B than the training instances t23 and t24 which have been used in combining. The synthetic instance t123 is generated at a position closer to the decision boundary B than the training instances t25 and t27 which have been used in combining. As such, the information processing apparatus 20 combines training instances which are respectively included in a plurality of spaces partitioned by the decision boundary B. Therefore, it is possible to generate a synthetic instance at a position closer to the decision boundary B than training instances which have been used in combining. By using a synthetic instance that is positioned closer to the decision boundary B, it is possible to more efficiently improve prediction accuracy of a machine learning model to be trained.

Moreover, in particular, in a case where a machine learning model to be trained is not a support vector machine, even if a synthetic instance is generated using a training instance near a decision boundary of a support vector machine, prediction accuracy of the machine learning model to be trained may not be improved. In contrast, according to the present example embodiment, the information processing apparatus 20 selects a synthetic instance using an uncertain training instance which has been selected not only by a process (the foregoing second selection process) of selecting a training instance which is present near a decision boundary of the support vector machine but also by another selection process (the foregoing first selection process, third selection process, or the like). Therefore, even in a case where a machine learning model to be trained is not a support vector machine, it is possible to efficiently improve prediction accuracy of a machine learning model which is different from a support vector machine.

Moreover, according to the present example embodiment, the information processing apparatus 20 selects an uncertain training instance using a machine learning model group that includes a plurality of machine learning models. This makes it possible to generate synthetic instances at more various locations in a feature quantity space. In other words, it is possible to prevent excessive generation of synthetic instances only near the decision boundary of the support vector machine.

Moreover, according to the present example embodiment, the information processing apparatus 20 trains one or more machine learning models using the generated synthetic instance. By using a synthetic instance that has been generated using one or more machine learning models which have been trained again, it is possible to more efficiently improve prediction accuracy of a machine learning model to be trained.

### <Variation>

In the above-described example embodiment, the selection section 23 selects, by at least one of the first selection process through the third selection process, a training instance which derives an uncertain prediction result. However, a technique for selecting a training instance which derives an uncertain prediction result is not limited to the technique exemplified in the above-described example embodiment. The selection section 23 may select, by another technique, a training instance which derives an uncertain prediction result. For example, the selection section 23 may select, by using an index of consensus entropy, a training instance which derives an uncertain prediction result.

### Third Example Embodiment

The following description will discuss a third example embodiment of the present invention in detail, with reference to the drawings. The same reference numerals are given to constituent elements which have functions identical with those described in the second example embodiment, and descriptions as to such constituent elements are not repeated.

In the present example embodiment, an example embodiment will be described which is obtained by altering the information processing apparatus 20 in accordance with the second example embodiment as follows. The generation section 24 of the information processing apparatus 20 generates a plurality of synthetic instances by repeatedly carrying out a synthetic instance generation process of generating a synthetic instance. In the present example embodiment, the synthetic instance generation process is a process of generating a synthetic instance by (i) selecting one of the first generation process and the second generation process based on a predetermined condition and (ii) carrying out the selected process. The first generation process is a process of combining a plurality of training instances which have been selected by the selection section 23. Meanwhile, the second generation process is a process of (i) extracting at least one training instance from the plurality of training instances selected by the selection section 23, and (ii) combining the extracted training instance and a training instance which is present, in a feature quantity space, near the extracted training instance.

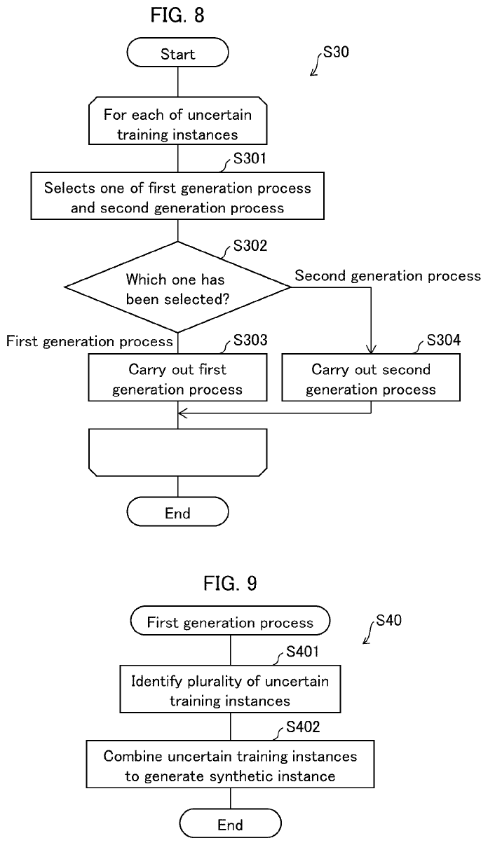

FIG. 8 is a flowchart illustrating a flow of a synthetic instance generation process S30 that is carried out by the generation section 24 in accordance with the present example embodiment. The generation section 24 carries out processes of steps S301 through S304 for each of uncertain training instances which have been selected by the selection section 23.

In step S301, the generation section 24 selects one of the first generation process and the second generation process based on a predetermined condition. The generation section 24 selects one of the first generation process and the second generation process based on, for example, a probability that is calculated based on a random number generated by a random function.

In step S302, the generation section 24 determines which one of the first and second generation processes has been selected. In a case where the first generation process has been selected, the generation section 24 proceeds to a process of step S303, and carries out the first generation process. Meanwhile, in a case where the second generation process has been selected, the generation section 24 proceeds to a process of step S304, and carries out the second generation process.

FIG. 9 is a flowchart illustrating a flow of a first generation process S40 carried out by the generation section 24. In step S401, the generation section 24 identifies a plurality of training instances which are part of the plurality of training instances which have been selected by the selection section 23. This identification process is similar to the identification process carried out by the selection section 23 in the above-described second example embodiment.

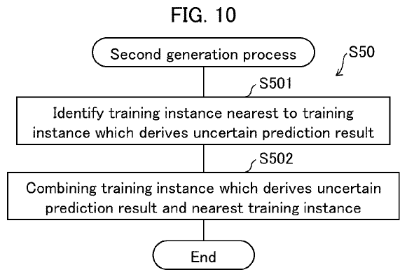

FIG. 10 is a flowchart illustrating a flow of a second generation process S50 carried out by the generation section 24. In step S501, the generation section 24 identifies, in the feature quantity space, a training instance which is nearest to the training instance which derives an uncertain prediction result. In step S502, the generation section 24 generates a synthetic instance by combining the uncertain training instance and the nearest training instance which has been identified in step S501.

### Example Advantage of Present Example Embodiment

According to the present example embodiment, the information processing apparatus 20 repeatedly carries out the generation process of generating a synthetic instance by (i) selecting, based on a predetermined condition, the first generation process or the second generation process, and (ii) carrying out the selected process. Therefore, the information processing apparatus 20 can generate synthetic instances having more various features. In other words, the information processing apparatus 20 can prevent generated synthetic instances from being uniform.

### Fourth Example Embodiment

The following description will discuss a fourth example embodiment of the present invention in detail, with reference to the drawings. The same reference numerals are given to constituent elements which have functions identical with those described in the second and third example embodiments, and descriptions as to such constituent elements are not repeated.

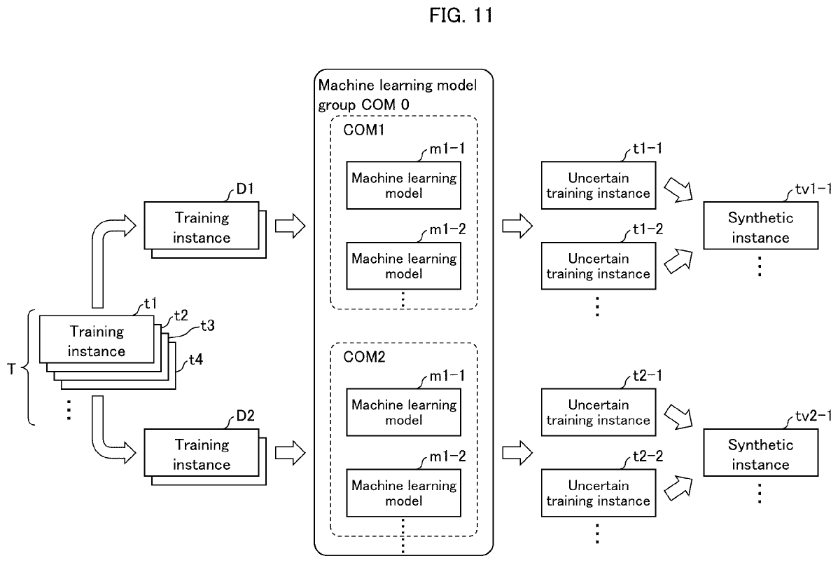

In the present example embodiment, an example embodiment will be described which is obtained by altering the information processing apparatus 20 in accordance with the second example embodiment as follows. The information processing apparatus 20 in accordance with the present example embodiment selects an uncertain training instance with use of a machine learning model group. FIG. 11 is a diagram schematically illustrating a specific example of an information processing method in accordance with the present example embodiment. In FIG. 11, the machine learning model group COM0 includes a plurality of machine learning model groups COM1, COM2, and so forth. The selection section 23 of the information processing apparatus 20 selects an uncertain training instance using a plurality of machine learning model groups COMi (1≤i≤M; M is an integer of 2 or more). A machine learning model group COM1 includes machine learning models m1-1, m1-2, and so forth. The machine learning model group COM2 includes machine learning models m2-1, m2-2, and so forth. Similarly, a machine learning model group COMi includes machine learning models mi-j (j=1, 2, and so forth). The training section 22 repeats, for i=1, 2, . . . , M, generation of a synthetic instance using the machine learning model groups COMi as follows.

Specifically, the training section 22 extracts a training instance group Di from a training instance group T which has been acquired by the acquisition section 21. For example, the training section 22 extracts a training instance group Di from the training instance group T by random sampling.

The training section 22 trains the machine learning model group COMi with use of the training instance group Di which has been extracted. That is, the training section 22 trains the machine learning models m1-1, m1-2, and so forth using the training instance group D1. Moreover, the training section 22 trains the machine learning models m2-1, m2-2, and so forth using the training instance group D2.

The training section 22 calculates, with use of the machine learning model group COMi, information indicating uncertainty of a training instance which has not been used in training. The information indicating uncertainty of a training instance is, for example, entropy in formula (2) described above. For example, the training section 22 calculates information indicating uncertainty based on prediction results obtained by inputting a training instance, which has not been used in training, into the machine learning models mi-j included in the machine learning model group COMi. For example, the training section 22 acquires prediction results by inputting, into the machine learning models m1-1, m1-2, and so forth, a training instance (i.e., a training instance which is not included in the training instance group D1) which has not been used in training of the machine learning model group COM1. The training section 22 calculates, based on the plurality of prediction results which have been acquired, information indicating uncertainty for each of a plurality of training instances which have been input into the machine learning model group COM1.

Moreover, the training section 22 acquires prediction results by inputting, into the machine learning models m2-1, m2-2, and so forth, a training instance (i.e., a training instance which is not included in the training instance group D2) which has not been used in training of the machine learning model group COM2. The training section 22 calculates, based on the plurality of prediction results which have been acquired, information indicating uncertainty for each of a plurality of training instances which have been input into the machine learning model group COM2.

In the example illustrated in FIG. 11, the selection section 23 selects, based on information indicating uncertainty which has been calculated for each training instance input into the machine learning model group COM1, training instances t1-1, t1-2, and so forth each of which derives variation in prediction results. Moreover, the selection section 23 selects, based on information indicating uncertainty which has been calculated for each training instance input into the machine learning model group COM2, training instances t2-1, t2-2, and so forth each of which derives variation in prediction results.

The generation section 24 generates a synthetic instance tv1-1 by selecting and combining two or more training instances from the training instance t1-1, the training instance t1-2, and so forth, and the training instance t2-1, the training instance t2-2, and so forth which have been selected by the selection section 23. In the example illustrated in FIG. 11, the generation section 24 generates a synthetic instance tv1-1 by combining the training instance t1-1 and the training instance t1-2 which have been selected by the selection section 23. Moreover, the generation section 24 generates a synthetic instance tv2-1 by combining the training instance t2-1 and the training instance t2-2 which have been selected by the selection section 23. Note that a combination of training instances to be combined is not limited to the combinations illustrated in FIG. 11, and may be another combination.

### Example Advantage of Present Example Embodiment

The present example embodiment employs the configuration of using a machine learning model group in order to select a training instance which derives an uncertain prediction result.

Therefore, the present example embodiment makes it possible to suppress generation of synthetic instances only in a certain region, as compared with a case where synthetic instances are generated near a decision boundary as in the technique disclosed in Non-patent Literature 1.

### Fifth Example Embodiment

The following description will discuss a fifth example embodiment of the present invention in detail, with reference to the drawings. The same reference numerals are given to constituent elements which have functions identical with those described in the second through fourth example embodiments, and descriptions as to such constituent elements are not repeated. The present example embodiment is an example embodiment obtained by altering the generation section 24 in the second example embodiment as follows.

### <Configuration of Generation Section>

In the present example embodiment, the generation section 24 generates a plurality of synthetic instances. Moreover, the generation section 24 integrates, into a single synthetic instance, two synthetic instances that satisfy a similarity condition among the plurality of synthetic instances, and outputs the single synthetic instance. Here, the similarity condition is a condition indicating that instances are similar to each other. The similarity condition may be, for example, that a cosine similarity is equal to or greater than a threshold, or that a distance in a feature quantity space is equal to or less than a threshold. Note, however, that the similarity condition is not limited to these. Details of the integration process will be described later.

### <Flow of Information Processing Method>

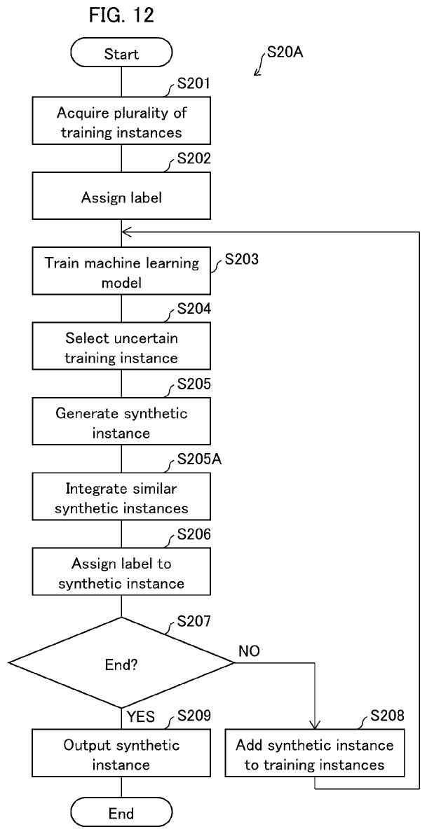

The following description will discuss an information processing method S20A in the present example embodiment, with reference to FIG. 12. FIG. 12 is a flowchart illustrating a flow of the information processing method S20A in accordance with the fifth example embodiment. The information processing method S20A illustrated in FIG. 12 is configured in a manner substantially similar to the information processing method S20 in accordance with the second example embodiment, except for a feature of further including step S205A.

### (Step S205A)

In step S205A, the generation section 24 integrates two similar synthetic instances among synthetic instances generated in step S205. Specifically, the generation section 24 determines whether or not a synthetic instance generated in step S205 this time and any of synthetic instances generated in step S205 at and before the previous time satisfy the similarity condition. In a case where it has been determined that the similarity condition is satisfied, the generation section 24 integrates two synthetic instances that satisfy the similarity condition.

### (Specific Example of Integration Process)

Examples of the integration process include a process of combining two synthetic instances. In this case, the generation section 24 generates a single synthetic instance by combining the two synthetic instances, and deletes the original two synthetic instances which satisfy the similarity condition. Another example of the integration process is a process of deleting one of the two synthetic instances. Note that the integration process only needs to be a process of employing, instead of two synthetic instances that satisfy the similarity condition, a single synthetic instance that has been generated with reference to the two synthetic instances of interest, and is not limited to the above-described process. Note that deleting a synthetic instance is to remove the synthetic instance from subjects to each of which a label is to be assigned in step S206 and from subjects to be added to training instances in step S208. As such, a label is assigned to the integrated synthetic instance, and the integrated synthetic instance is added to training instances.

### Example Advantage of Present Example Embodiment

In the present example embodiment, the configuration is employed in which the generation section generates a plurality of synthetic instances and integrates, into a single synthetic instance, two synthetic instances that satisfy a similarity condition among the plurality of synthetic instances which have been generated.

Here, in a case where a plurality of instances present in a region which is short of a training instance are similar to each other, it is not efficient, in improving accuracy of a machine learning model, to train the machine learning model using those instances. Therefore, by integrating synthetic instances that satisfy a similarity condition, the present example embodiment makes it possible to generate, in a region which is short of a training instance, a synthetic instance that can more efficiently improve accuracy of a machine learning model.

### Sixth Example Embodiment

The following description will discuss a sixth example embodiment of the present invention in detail, with reference to the drawings. The same reference numerals are given to constituent elements which have functions identical with those described in the second through fourth example embodiments, and descriptions as to such constituent elements are not repeated. The present example embodiment is an example embodiment obtained by altering the generation section 24 in the second example embodiment as follows.

### <Configuration of Generation Section>

In the present example embodiment, the generation section 24 outputs, among synthetic instances, one or more synthetic instances each of which derives one or more uncertain prediction results that are obtained using one or more machine learning models which have been trained by the training section 22. Here, the synthetic instance which derives an uncertain prediction result is a synthetic instance for which a result of evaluating uncertainty satisfies a predetermined condition. Details of the evaluation result of uncertainty that satisfies a predetermined condition are as described above, and therefore the details will not be repeated. In other words, the generation section 24 carries out ex-post facto evaluation of uncertainty of the generated synthetic instance using one or more machine learning models which have been trained, and employs a synthetic instance which has been found, by the ex-post facto evaluation, to derive an uncertain prediction result.

### <Flow of Information Processing Method>

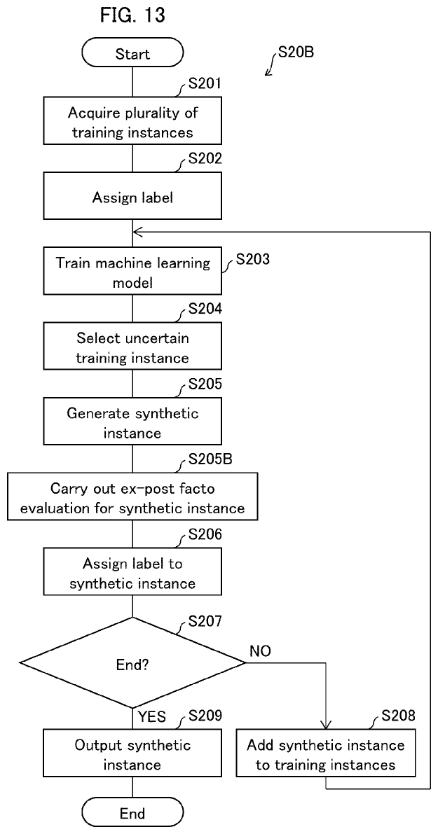

The following description will discuss an information processing method S20B in the present example embodiment, with reference to FIG. 13. FIG. 13 is a flowchart illustrating a flow of the information processing method S20B in accordance with the sixth example embodiment. The information processing method S20B illustrated in FIG. 13 is configured in a manner substantially similar to the information processing method S20 in accordance with the second example embodiment, except for a feature of further including step S205B.

### (Step S205B)

In step S205B, the generation section 24 carries out ex-post facto evaluation of a synthetic instance generated in step S205.

Specifically, the generation section 24 evaluates, for the synthetic instance of interest, uncertainty of a prediction result using one or more machine learning models. For example, in the example illustrated in FIG. 6, the generation section 24 evaluates uncertainty of a prediction result for the synthetic instance tv1-1 using the machine learning models m1, m2, and so forth. Details of the process of evaluating uncertainty of a prediction result using one or more machine learning models are as described in the second example embodiment.

In a case where a synthetic instance generated in step S205 has been evaluated not to derive an uncertain prediction result, the generation section 24 deletes that synthetic instance. Here, deleting a synthetic instance is to remove the synthetic instance from subjects to each of which a label is to be assigned in step S206 and from subjects to be added to training instances in step S208. As such, a label is assigned to a synthetic instance which derives an uncertain prediction result, and the synthetic instance is added to training instances.

### Example Advantage of Present Example Embodiment

The present example embodiment employs the configuration in which the generation section outputs, among generated synthetic instances, a synthetic instance which derives an uncertain prediction result that is obtained using one or more machine learning models which have been trained.

Here, a synthetic instance obtained by combining training instances each of which derives an uncertain prediction result does not necessarily derive an uncertain prediction result. In other words, the synthetic instance thus generated may not derive an uncertain prediction result. It is not efficient, in improving accuracy of a machine learning model, to train the machine learning model using a training instance which does not derive an uncertain prediction result. Therefore, by carrying out ex-post facto evaluation for the generated synthetic instance, the present example embodiment makes it possible to generate, in a region which is short of a training instance, a synthetic instance that can more efficiently improve accuracy of a machine learning model.

### [Software Implementation Example]

Some or all of the functions of the information processing apparatuses 10 and 20 (hereinafter, referred to as “information processing apparatus 10, etc.”) may be implemented by hardware such as an integrated circuit (IC chip), or may be implemented by software.

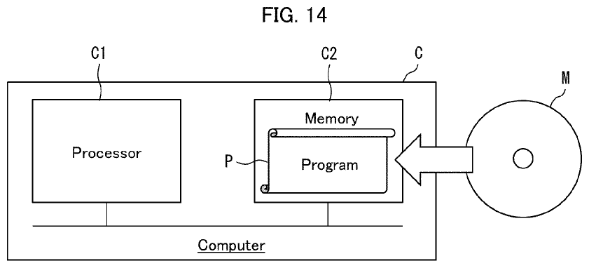

In the latter case, each of the information processing apparatus 10, etc. is realized by, for example, a computer that executes instructions of a program that is software realizing the foregoing functions. FIG. 14 illustrates an example of such a computer (hereinafter, referred to as “computer C”). The computer C includes at least one processor C1 and at least one memory C2. The memory C2 stores a program P for causing the computer C to function as the information processing apparatus 10, etc. In the computer C, the processor C1 reads the program P from the memory C2 and executes the program P, so that the functions of the information processing apparatus 10, etc. are implemented.

Examples of the processor C1 include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some or all of the foregoing example embodiments can also be described as below. Note, however, that the present invention is not limited to the following supplementary notes.

### (Supplementary Note 1)

An information processing apparatus, including: an acquisition means for acquiring a plurality of training instances; a selection means for selecting, from the plurality of training instances, two or more training instances each of which derives one or more uncertain prediction results obtained using one or more machine learning models that output prediction results while using instances as input; and a generation means for generating a synthetic instance by combining the two or more training instances which have been selected by the selection means.

According to the configuration, it is highly likely that a synthetic instance obtained by combining, by the information processing apparatus, two or more training instances each of which derives an uncertain prediction result is generated at a location which is short of a prediction result in a feature quantity space. Therefore, by training a machine learning model to be trained using the generated synthetic instance, it is possible to more efficiently improve prediction accuracy of the machine learning model to be trained.

### (Supplementary Note 2)

The information processing apparatus according to supplementary note 1, further including: a training means for training at least one of or all of the one or more machine learning models using at least one of or all of the plurality of training instances.

According to the configuration, a machine learning model is trained using a synthetic instance generated by the information processing apparatus. Therefore, it is possible to more efficiently improve prediction accuracy of the machine learning model to be trained.

### (Supplementary Note 3)

The information processing apparatus according to supplementary note 1 or 2, in which: the two or more training instances which are selected by the selection means include a training instance that derives variation in a plurality of prediction results obtained using a plurality of machine learning models.

According to the configuration, the information processing apparatus selects a training instance which derives variation in a plurality of prediction results obtained using a plurality of machine learning models. By training a machine learning model using a synthetic instance that is obtained by combining training instances selected by the information processing apparatus, it is possible to more effectively improve prediction accuracy of the machine learning model to be trained.

### (Supplementary Note 4)

The information processing apparatus according to any one of supplementary notes 1 through 3, in which: the two or more training instances selected by the selection means include a training instance that is present near a decision boundary in a feature quantity space of at least one machine learning model; and the selection means selects, from the plurality of training instances, training instances which are respectively included in a plurality of spaces partitioned by the decision boundary in the feature quantity space.

According to the configuration, it is highly likely that a synthetic instance obtained by combining two or more training instances each of which derives an uncertain prediction result is generated at a location near the decision boundary than the training instances used in combining. Therefore, by training a machine learning model using the generated synthetic instance, it is possible to more efficiently improve prediction accuracy of the machine learning model to be trained.

### (Supplementary Note 5)

The information processing apparatus according to supplementary note 2, in which: the synthetic instance is added to the plurality of training instances, and the acquisition means, the training means, the selection means, and the generation means are caused to function again.

According to the configuration, the information processing apparatus trains one or more machine learning models using the generated synthetic instance, and generates a synthetic instance using the one or more machine learning models which have been trained again. By using a synthetic instance generated by the information processing apparatus, it is possible to more efficiently improve prediction accuracy of a machine learning model to be trained.

### (Supplementary Note 6)

The information processing apparatus according to any one of supplementary notes 1 through 5, in which: the generation means generates a plurality of synthetic instances, and integrates, into a single synthetic instance, two synthetic instances that satisfy a similarity condition among the plurality of synthetic instances.

According to the configuration, synthetic instances that satisfy a similarity condition among synthetic instances generated by the information processing apparatus are integrated, and this makes it possible to prevent generation of synthetic instances having a high degree of similarity.

### (Supplementary Note 7)

The information processing apparatus according to supplementary note 2, in which: the generation means outputs, among synthetic instances, one or more synthetic instances each of which derives one or more uncertain prediction results that are obtained using the one or more machine learning models which have been trained by the training means.

According to the configuration, the information processing apparatus carries out ex-post facto evaluation of a synthetic instance using a machine learning model which has been trained, and outputs a synthetic instance which actually derives an uncertain prediction result of the machine learning model. By using the output synthetic instance for training, it is possible to more efficiently train a machine learning model to be trained.

### (Supplementary Note 8)

The information processing apparatus according to any one of supplementary notes 1 through 7, in which: the one or more machine learning models include a machine learning model to be trained using the synthetic instance.

According to the configuration, the information processing apparatus 10 generates a synthetic instance by combining training instances each of which derives one or more uncertain prediction results obtained using a machine learning model(s) to be trained. This makes it possible to more efficiently improve prediction accuracy of the machine learning model to be trained.

### (Supplementary Note 9)

The information processing apparatus according to any one of supplementary notes 1 through 8, in which: the selection means selects, from the plurality of training instances, two or more training instances each of which derives a plurality of uncertain prediction results that are obtained using a plurality of machine learning models; and at least two of the plurality of machine learning models use machine learning algorithms which are different from each other.

According to the configuration, the information processing apparatus selects, with use of a plurality of machine learning models that use machine learning algorithms which are different from each other, training instances to be combined. Therefore, various training instances are selected as training instances each of which derives an uncertain prediction result, and this makes it possible to prevent generated synthetic instances from being uniform.

### (Supplementary Note 10)

The information processing apparatus according to any one of supplementary notes 1 through 8, in which: the selection means selects, from the plurality of training instances, two or more training instances each of which derives a plurality of uncertain prediction results that are obtained using a plurality of machine learning models; and the plurality of machine learning models use a single machine learning algorithm.

According to the configuration, by training a machine learning model to be trained using the generated synthetic instance, it is possible to more efficiently improve prediction accuracy of the machine learning model to be trained.

### (Supplementary Note 11)

The information processing apparatus according to supplementary note 8, in which: at least one machine learning model to be trained is a decision tree.

According to the configuration, by training a decision tree using a synthetic instance generated by the information processing apparatus, it is possible to more efficiently improve prediction accuracy of the decision tree.

### (Supplementary Note 12)

The information processing apparatus according to any one of supplementary notes 1 through 11, further including: a label assignment means for assigning a label to each of at least one of or all of the plurality of training instances and the synthetic instance.

According to the configuration, it is possible to train a machine learning model with use of a training technique which is premised on an assumption that a label is assigned to an instance.

### (Supplementary Note 13)

The information processing apparatus according to any one of supplementary notes 1 through 12, in which: the generation means generates a plurality of synthetic instances by repeatedly carrying out a generation process of selecting a first generation process and a second generation process based on a predetermined condition, and carrying out a process which has been selected to generate a synthetic instance, the first generation process being a process of combining a plurality of training instances selected by the selection means, and the second generation process being a process of extracting at least one training instance from the plurality of training instances selected by the selection means, and combining the at least one training instance which has been extracted and a training instance which is present, in a feature quantity space, near the at least one training instance which has been extracted.

According to the configuration, the generation process is repeatedly carried out which generates a synthetic instance by (i) selecting, based on a predetermined condition, the first generation process and the second generation process, and (ii) carrying out the selected process. Therefore, the information processing apparatus can generate synthetic instances having more various features.

### (Supplementary Note 14)

An information processing method, including: acquiring, by an information processing apparatus, a plurality of training instances; selecting, from the plurality of training instances by the information processing apparatus, two or more training instances each of which derives one or more uncertain prediction results obtained using one or more machine learning models that output prediction results while using instances as input; and generating, by the information processing apparatus, a synthetic instance by combining the two or more training instances which have been selected.

According to the configuration, an example advantage similar to that of supplementary note 1 is brought about.

### (Supplementary Note 15)

A program for causing a computer to function as an information processing apparatus, the program causing the computer to function as: an acquisition means for acquiring a plurality of training instances; a selection means for selecting, from the plurality of training instances, two or more training instances each of which derives one or more uncertain prediction results obtained using one or more machine learning models that output prediction results while using instances as input; and a generation means for generating a synthetic instance by combining the two or more training instances which have been selected by the selection means.

According to the configuration, an example advantage similar to that of supplementary note 1 is brought about.

### (Supplementary Note 16)

A computer-readable storage medium storing a program described in supplementary note 15.

According to the configuration, an example advantage similar to that of supplementary note 1 is brought about.

### [Additional Remark 3]

Furthermore, some of or all of the foregoing example embodiments can also be expressed as below.

An information processing apparatus including at least one processor, the at least one processor carrying out: an acquisition process of acquiring a plurality of training instances; a selection process of selecting, from the plurality of training instances, two or more training instances each of which derives one or more uncertain prediction results obtained using one or more machine learning models that output prediction results while using instances as input; and a generation process of generating a synthetic instance by combining the two or more training instances which have been selected.

Note that the information processing apparatus can further include a memory. The memory can store a program for causing the at least one processor to execute the acquisition process, the selection process, and the generation process. The program can be stored in a computer-readable non-transitory tangible storage medium.

### REFERENCE SIGNS LIST

10, 20: Information processing apparatus
11, 21: Acquisition section (acquisition means)
12, 23: Selection section (selection means)
13, 24: Generation section (generation means)
22: Training section (training means)
25: Label assignment section (label assignment means)
26: Output section (output means)
27: Control section
S10, S20, S20A, S20B: Information processing method

What is claimed is:

1. An information processing apparatus, comprising at least one processor, the at least one processor carrying out:
an acquisition process of acquiring a plurality of training instances;
a selection process of selecting, from the plurality of training instances, two or more training instances each of which derives one or more uncertain prediction results obtained using one or more machine learning models that output prediction results while using instances as input; and
a generation process of generating a synthetic instance by combining the two or more training instances which have been selected in the selection process.

2. The information processing apparatus according to claim 1, wherein:
the at least one processor further carries out a training process of training at least one of or all of the one or more machine learning models using at least one of or all of the plurality of training instances.

3. The information processing apparatus according to claim 1, wherein:
the two or more training instances which are selected by the at least one processor in the selection process include a training instance that derives variation in a plurality of prediction results obtained using a plurality of machine learning models.

4. The information processing apparatus according to claim 1, wherein:
the two or more training instances selected by the at least one processor in the selection process include a training instance that is present near a decision boundary in a feature quantity space of at least one machine learning model; and
in the selection process, the at least one processor selects, from the plurality of training instances, training instances which are respectively included in a plurality of spaces partitioned by the decision boundary in the feature quantity space.

5. The information processing apparatus according to claim 2, wherein:
the at least one processor adds the synthetic instance to the plurality of training instances, and carries out the acquisition process, the training process, the selection process, and the generation process again.

6. The information processing apparatus according to claim 1, wherein:
in the generation process, the at least one processor generates a plurality of synthetic instances, and integrates, into a single synthetic instance, two synthetic instances that satisfy a similarity condition among the plurality of synthetic instances.

7. The information processing apparatus according to claim 2, wherein:
in the generation process, the at least one processor outputs, among synthetic instances, one or more synthetic instances each of which derives one or more uncertain prediction results that are obtained using the one or more machine learning models which have been trained by the training process.

8. The information processing apparatus according to claim 1, wherein:
the one or more machine learning models include a machine learning model to be trained using the synthetic instance.

9. The information processing apparatus according to claim 1, wherein:
in the selection process, the at least one processor selects, from the plurality of training instances, two or more training instances each of which derives a plurality of uncertain prediction results that are obtained using a plurality of machine learning models; and
at least two of the plurality of machine learning models use machine learning algorithms which are different from each other.

10. The information processing apparatus according to claim 1, wherein:
in the selection process, the at least one processor selects, from the plurality of training instances, two or more training instances each of which derives a plurality of uncertain prediction results that are obtained using a plurality of machine learning models; and
the plurality of machine learning models use a single machine learning algorithm.

11. The information processing apparatus according to claim 8, wherein:
at least one machine learning model to be trained is a decision tree.

12. The information processing apparatus according to claim 1, wherein:
the at least one processor further carries out a label assignment process of assigning a label to each of at least one of or all of the plurality of training instances and the synthetic instance.

13. The information processing apparatus according to claim 1, wherein:
in the generation process, the at least one processor generates a plurality of synthetic instances by repeatedly carrying out a process of selecting a first generation process and a second generation process based on a predetermined condition, and carrying out a process which has been selected to generate a synthetic instance,
the first generation process being a process of combining a plurality of training instances selected in the selection process, and
the second generation process being a process of extracting at least one training instance from the plurality of training instances selected in the selection process, and combining the at least one training instance which has been extracted and a training instance which is present, in a feature quantity space, near the at least one training instance which has been extracted.

14. An information processing method, comprising:
acquiring, by an information processing apparatus, a plurality of training instances;
selecting, from the plurality of training instances by the information processing apparatus, two or more training instances each of which derives one or more uncertain prediction results obtained using one or more machine learning models that output prediction results while using instances as input; and
generating, by the information processing apparatus, a synthetic instance by combining the two or more training instances which have been selected.

15. A computer-readable non-transitory storage medium storing a program for causing a computer to function as an information processing apparatus, the program causing the computer to carry out:
an acquisition process of acquiring a plurality of training instances;
a selection process of selecting, from the plurality of training instances, two or more training instances each of which derives one or more uncertain prediction results obtained using one or more machine learning models that output prediction results while using instances as input; and
a generation process of generating a synthetic instance by combining the two or more training instances which have been selected in the selection process.
